(19) United States
(12) Patent Application Publication
(10) Pub. No.: US 2018/0336539 A1
(43) Pub. Date: Nov. 22, 2018

(54) PROCESSING EVENT DATA PROVIDED BY COMPONENTS OF PAYMENT NETWORKS TO DETERMINE ISSUES

(71) Applicant: EntIT Software LLC, Sunnyvale, CA (US)

(72) Inventors: Manish Upasani, Sunnyvale, CA (US); Ashwin Aruldas, Concord, NC (US)

(21) Appl. No.: 15/600,969

(22) Filed: May 22, 2017

(51) Int. Cl. G06Q 20/10; G06Q 20/40

(52) U.S. Cl. CPC G06Q 20/1085; G06Q 20/4012

(57) ABSTRACT

A technique includes communicating with a plurality of components of a payment network to receive event data, which is provided by the plurality of components. The plurality of components include electronic retail payment endpoints and a hardware security module. The technique includes processing the event data that is provided by the plurality of components to determine an issue associated with a given component of the plurality of components.

### BACKGROUND

A cardholder may use a credit or debit card for such purposes as obtaining cash from an automated teller machine (ATM) or, via a point of sale terminal, transferring funds to a merchant for purposes of paying for goods or services. Such electronic transactions may involve the use of a payment network, which serves as an intermediary between the cardholder, the merchant, the acquiring financial institution (the bank associated with the point of sale terminal or ATM, for example) and the issuing financial institution (the bank associated with the particular credit or debit card, for example). In addition to endpoint components, such as ATMs and point of sale terminals, the payment network may include various other components, such as host applications that execute on bank servers; hardware security modules that store and manage keys associated with financial transactions; and so forth.

### BRIEF DESCRIPTION OF THE DRAWINGS

FIG. 1 is a schematic diagram of a payment network according to an example implementation.

FIG. 2 is a schematic diagram of a system information and event management (SIEM) engine of the payment network of FIG. 1 according to an example implementation.

FIGS. 3 and 4 are flow diagrams depicting techniques to determine security issues associated with a payment network according to example implementations.

FIG. 5 is a schematic diagram of an apparatus to determine security issues associated with a payment network according to an example implementation.

### DETAILED DESCRIPTION

Even though a payment network may be a closed domain, the network may potentially be associated with various security issues. In this context, an “issue” generally refers to a behavior, state, incident or matter; and an “issue being associated with the payment network” refers to a behavior, state, incident or matter that is related, correlated or connected to operation of the payment network and/or interaction of users (customers, merchant employees, employees of financial institutions, maintenance workers, and so forth) with the payment network. A “security issue” refers to a behavior, state, incident or matter that affects, may affect or at least appears to affect the integrity of the payment network, including issues that affect, may affect or appear to affect assets (machines, computers, automated teller machines (ATMs), and so forth) of the payment network and/or assets that are protected and accessed using the payment network, such as accounts of financial institiutions, currency stored inside ATMs, and so forth. A “security issue” may or may not arise from malicious activity. As examples, a security issue may attributable to such non-malicious activity as equipment failure that is not connected with malicious activity or the execution of non-malicious software having a design flaw, or “bug.” Moreover, an issue may initially appear to be a security issue, but investigation may reveal otherwise (an atypical high rate of transactions at a particular ATM may be associated with benign activity as opposed to being connected to fraudulent activity, for example).

As examples, a security issue may be a communication error, a number of operations exceeding a threshold, a change in a protocol, a communication or hardware failure, a dollar threshold amount being exceeded, a certain pattern of transactions or communications, an atypical transaction rate, a personal identification number (PIN) not being verified, acitivty consistent with fraudulent or malicious activity, and so forth.

As a more specific example, an ATM of the payment network may be subject to a card skimming attack. In this manner, a rogue capturing device may be affixed to a card reader slot on the ATM for purposes of emulating a card slot and capturing PINs and the associated account numbers with credit and debit cards that are used at the ATM. These captured account numbers and PINs, in turn, may be used to create rogue cards that may be used to fraudulently transfer funds from the financial institutions that issued the cards. As another example, a rogue point of sale terminal may be connected to the payment network for purposes of fraudulently transferring funds from financial institutions.

One way to identify security issues with a payment network is to focus on the behaviors of its components. For example, the rate of transactions that are conducted at a particular endpoint of the payment network, such as an ATM or a point of sale terminal, may be monitored so that when the transaction rate is relatively large, as compared to a historical average transaction rate, the appropriate personnel may be alerted to the observed atypical behavior.

In accordance with example implementations that are described herein, a payment network includes one or multiple system information and event management (SIEM) engines. The SIEM engine applies correlation rules to events of the payment network for purposes of identifying issues that are associated with the payment network and generating corresponding alerts so that the appropriate corrective action may be taken. In this context, “identifying an issue that is associated with the payment network” refers to determining or detecting a behavior, state, incident or matter that arises due to operation of the payment network and/or interaction of users with the payment network.

An “event” refers to a transaction or occurrence arising from the payment network. An event, in general, is associated with an activity or state of a component of the payment network. A “correlation rule” refers to a predefined event category or a predefined relationship among multiple events, which are deemed to be associated with one or multiple security issues. In accordance with example implementations, the application of a given correlation rule to one or multiple events associated with the payment network provides a result, which represents whether an issue is associated with the event(s) (i.e., the application of the correlation rule may provide a result which determines or detects whether an issue is linked, connected, related or correlated to the event(s)). In this manner, depending on the particular implementation, the result may be a binary representation of whether the event(s) are or are not associated with a particular issue; may represent a probability that the event(s) are associated with a particular issue; may classify the event(s) as belonging to particular issue classification; and so forth.

An “alert” refers to an alarm, notice or other action which brings attention to a security issue. For example, an alert may bring an associated issue to the attention of an entity (a human, a computer, and so forth) so that one or multiple actions may be taken to address the issue. As examples, these actions may include corrective actions involving a component or components of the payment network, which are associated with the alert, such as actions to shut down defective component(s) or take the component(s) offline; actions to mitigate damages stemming from detected rogue component(s); actions to prevent certain operations associated with component(s); actions to schedule and/or perform maintenance on component(s) to repair or replace defective parts; and so forth. The alert may also initiate further investigation of one or multiple components of the payment network. As examples, an alert may be an electronic mail (email) message; an audio or visual cue; an entry in a log of detected issues; a short message service (SMS) message; a phone call; and so forth.

In accordance with example implementations, the components of the payment network may include hardware security modules (HSMs), endpoint components (point of sale components, ATMs, store controllers, and so forth) and host applications. In this context, a “hardware security module,” or “HSM,” refers to a physical machine (a physical computing device, for example), which stores and manages digital keys for the payment network. The hardware security module may alternatively be called a “network security processor.” In accordance with some implementations, the hardware security module has a set of associated security policies, such as, for example, a policy that controls whether the HSM may decrypt digital keys. Moreover, in accordance with some implementations, the security policies for a given HSM may dictate the particular aspects of cryptographic processing that may be employed by the HSM. As more specific examples, in accordance with some implementations, a given HSM may be a blade that is inserted into a rack or may be a standalone device. Moreover, in accordance with example implementations, the HSM may be physically connected to an associated server at a financial institution via a direct cable connection to the server.

In accordance with example implementations, an “endpoint component” of the payment network refers to a component that provides a user interface for purposes of initiating and conducting a financial transaction. For example, the endpoints may include ATMs and point of sale terminals. In this manner, a given customer may, through an endpoint component, such as an ATM or point of sale terminal, provide information associated with a debit or credit card that was issued to the customer by a financial institution. By entering account information contained on this card, along with the appropriate PIN, the customer may, for example, receive cash from the endpoint component or transfer funds to a merchant to pay for goods or services.

The “host application” refers to a set of machine executable instructions that executes on one or multiple physical computing machines (one or multiple servers, for example) that are associated with a particular financial institution. In this manner, a host application may be associated with a particular financial institution, may execute on a server that is physically located in a secure facility of the institution, and may have restricted access to a limited set of personnel of the institution. Moreover, the may be directly connected (via a cable connection, for example) to an HSM that also is physically located at the secure facility.

In general, a host application may communicate with endpoints of the payment network, which are associated with the same financial institution as the host application; and the host application may communicate with one or multiple other host applications (associated with other financial institutions) via a switch, as further described herein. Moreover, in accordance with example implementations, a given SIEM engine may be associated with a financial institution, a host application, an HSM and a set of endpoint components.

The SIEM engine, in accordance with example implementations, may determine or identify security issues and health issues. In this manner, a “security issue” refers to an issue relating to the integrity and/or protection of assets (PINs, keys, passwords, credentials, monetary assets of associated financial institutions, and so forth) associated with the payment network. A given security issue may arise due to, as examples, ATM card skimming, rogue point of sale terminals, HSM tampering, malware intrusion, and so forth. Health issues generally relate to the condition or state of hardware and software components of the payment network. As examples, a health issue may arise due to a backup battery failing, a network communication interface failing, software becoming corrupted or nonfunctional, and so forth. Some issues may be both health and security related. For example, the SIEM may detect the failure of a battery of an HSM, which may be due to tampering with the HSM.

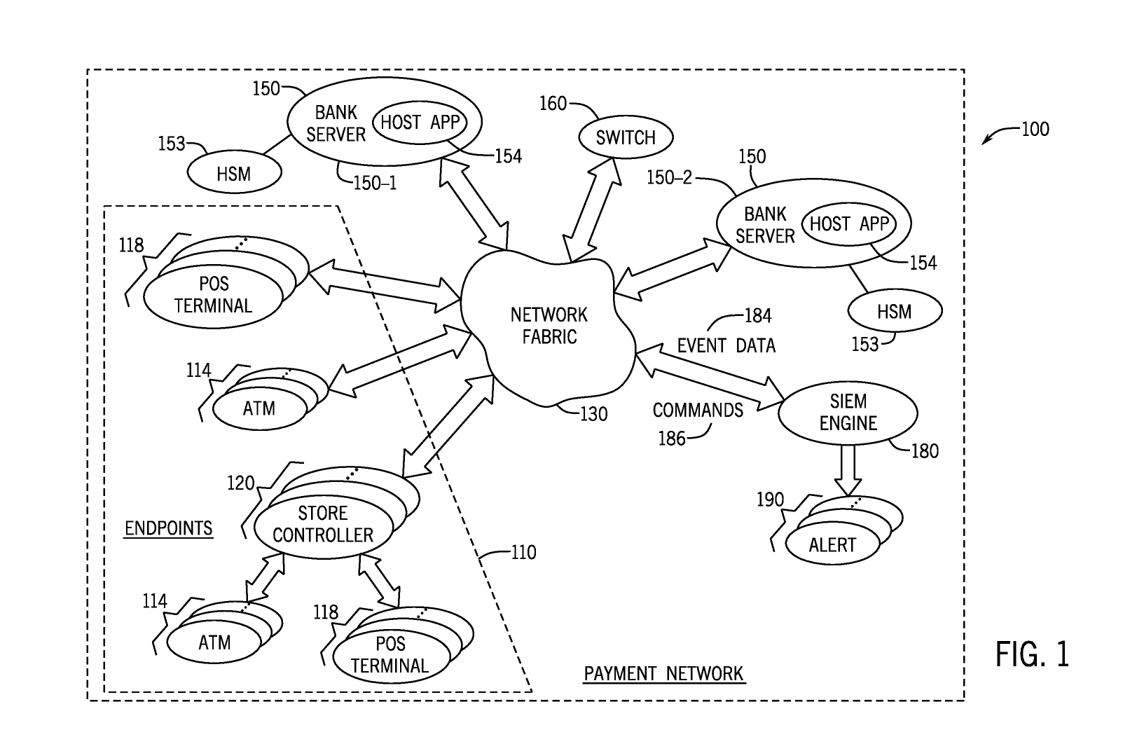

Referring to FIG. 1, in accordance with example implementations, a payment network 100 includes endpoints 110, such as one or multiple point of sale terminals 118 and one or multiple ATMs 114. Moreover, as depicted in FIG. 1, in accordance with example implementations, the endpoints 110 may include one or multiple store controllers 120. As an example, a given store controller 120 may be used by a particular merchant for purposes of acquiring financial information from a customer for purposes of initiating a financial transaction with the payment network 100. As an example, a given store controller 120 may, in accordance with some implementations, be connected to one or multiple ATMs 114 as well as one or multiple point of sale terminals 118.

The endpoints 110 are connected through network fabric 130 to one or multiple bank servers 150 (bank servers 150-1 and 150-2 being depicted as examples in FIG. 1). In this manner, the network fabric 130 may be a private network fabric and may be formed from components and used protocols that are associated with any type of communication network such as (as examples) Fiber Channel Networks, iSCSI networks, ATA over Ethernet (AoE) networks, HyperSCSI networks, local area networks (LANs), wide area networks (WANs), global networks (the Internet, for example), or any combination thereof.

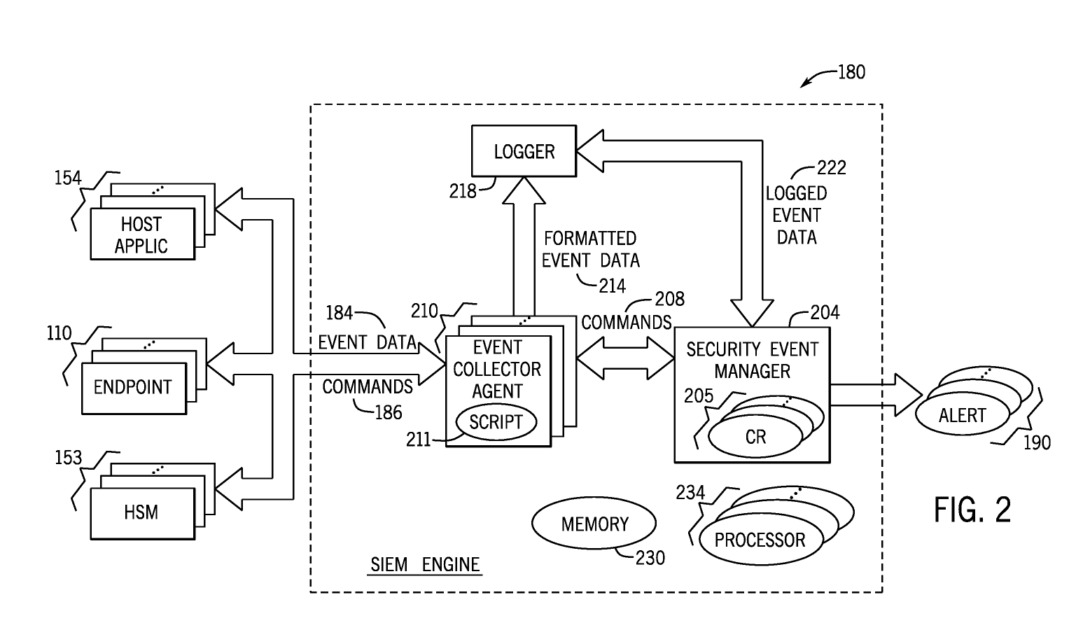

The bank server 150, in accordance with example implementations, refers to one or multiple physical machines that are controlled and secured by an associated financial institution. It is noted that although FIG. 2 depicts two bank servers 150-1 and 150-2, the payment network 100 may contain more than two bank servers 150, in accordance with example implementations. For a given financial transaction, one bank server 150 may be associated with a financial institution that is the acquirer (i.e., the financial institution associated with the endpoint involved in the financial transaction), and another bank server 150 may be associated with a financial institution that is the issuer (i.e., the financial institution that is the issuer of the card involved in the financial transaction).

For example, a customer may use the customer's debit or credit card at a given point of sale terminal 118, and this card may be associated with a particular financial institution that is the issuer of the card. The point of sale terminal used by the customer, in turn, may be associated with another financial institution, which is the acquirer for this transaction. As a more specific example, it may be assumed that the bank server 150-1 is a server associated with the acquirer for a given transaction, and the bank server 150-2 is associated with the issuer. Therefore, a host application 154 executing on the bank server 150-1 may receive the PIN and account information from the card and communicate with the bank server 150-2 for purposes of verifying the transaction before communicating with the point of sale terminal 118 to validate the transaction. For this purpose, the host application executing on the bank server 150-1 may communicate with a host application executing on the bank server 150-2 via a mechanism called a “switch” 160. In general, the “switch” refers to a hardware and/or software mechanism of the payment network 100 used by financial institutions to communicate with each other such as allowing host applications 154 on the bank servers 150-1 and 150-2 to communicate with each other.

As depicted in FIG. 1, in accordance with example implementations, each host application 154 may be connected to a corresponding hardware security module 153. As an example, the HSM 153 may be directly connected by a cable to the bank server 150 that executes the host application 154 for purposes of storing and managing keys involved with the various financial transactions that may be conducted by the host application 154.

In accordance with example implementations, the payment network 100 includes one or multiple SIEM engines 180. Each SIEM engine 180, in turn, may be associated with a particular financial institution and as such, may be associated with the endpoints 110, host application 154 and HSM 153, which are also associated with the financial institution. In accordance with example implementations, the SIEM engine 180 communicates commands 186 to the endpoints 110 (via the network fabric 130) for purposes of causing (as described further herein) the endpoints 110 to communicate event data 184 to the SIEM engine 180. The SIEM engine 180, in turn, applies correlation rules to the event data 184 for purposes of determining, or identifying, one or multiple issues that may be associated with the payment network 100.

Thus, as a result of applying the correlation rules to the event data 184, the SIEM engine 180 may identify issues with the payment network 100, and in accordance with example implementations, the SIEM engine 180 selectively generates alarms, or alerts 190. In this context, “selectively” generating the alerts 190 means that, in accordance with example implementations, the SIEM engine 180 may or may not generate the alert 190 depending on the particular identified issue. In this manner, in accordance with some implementations, the SIEM engine 180 may prioritize the identified issues so that higher priority issues trigger corresponding alerts 190, whereas relatively lower priority security issues are stored, or logged, for later review by personnel. In accordance with yet further example implementations, the SIEM engine 180 may report all issues, via alerts 190, to the appropriate personnel. Moreover, some alerts 190 may be directed to human operators, whereas other alerts 190 may automatically initiate corrective actions (as examples, an alert 190 may automatically take an ATM at which card skimming activity has been detected off line, or an alert 190 may schedule maintenance to replace a failed battery or other part of an HSM 153. In accordance with some implementations, the alerts 190 for health issues may be logged in an alert queue, log, whereas alerts 190 for security issues may result in messages being sent to the appropriate personnel.

Referring to FIG. 2 in conjunction with FIG. 1, in accordance with example implementations, the SIEM engine 180 includes a security event manager 204, which receives logged event data 222 from the components of the payment network 100, such as the endpoints 110, the HSMs 153 and the host applications 154. In this context, the “event data” provided by a given component of the payment network 100 refers to data representing actions, occurrences and/or states associated with the component. In this manner, the event data provided by a given component of the payment network may include data representing the occurrence of a particular transaction by the component as well as an identification of the transaction; a number of occurrences for a given transaction or multiple transactions; a status of the component; an error associated with the component; an output provided by the component; an input received by the component; a change in a policy by the component; a change in a battery state of the component; a battery state of the component decreasing below a certain threshold; a number of certain transactions conducted by the component exceeding a predefined threshold; data representing a state of the component at a given time; a rate of certain transactions conducted by the component; and so forth.

As a specific example, an ATM 114 (i.e., an endpoint 110) may provide event data that represents card-initiated financial transactions that have been conducted using the ATM 114; a rate of card transactions conducted with the ATM 114; failed transactions occurring at the ATM 114; a rate of failed transactions occurring at the ATM 114; a number of failed transactions occurring at the ATM 114; a number or rate of successful transactions occurring at the ATM 114; and so forth. As another example, a host application 154 may, for example, provide event data representing an inventory state (a state of the host application's inventory of point of sale controllers, for example); errors with a particular endpoint 110; PIN verified errors from a particular ATM; and so forth. As another example, a particular HSM 153 may provide event data representing an event in which a user did not enter the correct PIN from a given ATM; a rate at which users did not enter correct PINs from a given ATM; and so forth.

The security event manager 204, in general, applies a set of correlation rules 205 to the logged event data 222 for purposes of identifying issues with the payment network 100. In this manner, by applying the correlation rules 205 to the logged event data 222, the security event manager 204 may, in accordance with example implementations, deterministically identify events, event patterns and states, which are associated with issues for the payment network 100.

In accordance with some implementations, the application of the correlation rules 205 to the logged event data 222 may involve applying a set of IF . . . THEN rules to the event data to identify issues if application of the IF . . . THEN rules produce a Boolean “True” result. In accordance with further example implementations, application of a given set of correlation rules 205 to the logged event data 222 may produce a probability or probability density function, which the security engine 204 may then evaluate for purposes of identifying a corresponding issue. In accordance with further example implementations, application of the correlation rules 205 to the logged event data 222 may involve comparing a number (a number representing a total or a rate, as examples) to a predefined threshold such that based on the relationship of the number to the predefined threshold, the security event manager 204 may determine whether there is an associated issue. In yet further example implementations, application of the correlation rules 205 to the logged event data 222 may involve classifying certain sets of logged event data into corresponding issue classifications along with corresponding confidence levels in the classifications.

As a more specific example, in accordance with some implementations, the security event manager 204 may apply the correlation rules 205 to the logged event data 222 for purpose of card skimming fraud detection. For this purpose, the application of the correlation rules 205 to the logged event data 204 may consider trend analyses, PIN verification errors occurring at the ATMs 114, PIN verification errors occurring at the HSMs 153, location-based alerts from endpoints 110, and so forth.

As a more specific example, the security event manager 204 may receive logged event data 222 originating with a given ATM 114, which indicates a rate of transactions that have been conducted with the ATM 114. For example, the rate may indicate a number of transactions occurring per unit of time (the number of transactions per hour, for example). The logged event data 222 may also include event data originating from a host application 154, and the host application 154 may be associated with the given ATM 114 for this example. The event data from the host application 154 may, for example, represent a number of PIN verification errors, as reported by the ATM 114.

In this context, a “PIN verification error” refers to the failure of the payment network 100 to authenticate a PIN that is entered by a cardholder attempting to conduct a financial transaction with the payment network 100. PIN verification errors may arise due to different reasons. For example, one reason for a PIN verification error is that a cardholder enters the incorrect PIN for the card when conducting a transaction at the ATM 114. This failure may be the result of an authorized cardholder failing to enter the correct PIN (due to a typing error or due to the failure of the cardholder to properly remember the PIN), or the failure may be due to, for example, an unauthorized cardholder attempting to guess the PIN for improper purposes. A PIN verification error may, however, occur when a correct PIN is entered at the ATM 114, but a communication error occurs in the payment network 100, thereby preventing the PIN entry from being verified. For example, a cardholder may enter a correct PIN, but due to a checksum error occurring in the communication of the entered PIN to the host application or HSM 153, a PIN verification error may result.

By applying one or multiple correlation rules 205 to the event data provided by the ATM 114, the host application 154 and the HSM 153 (for this example), the security event manager 204 may determine whether a card skimming attack has occurred with the ATM 114. For example, the following set of results may indicate, or represent, that a card skimming attack has or is occurring with this particular ATM 114: the ATM 114 has a transaction rate that exceeds its historical transaction rate by a predetermined degree (a current transaction rate that is ten times its historical rate for the particular day or time of day, for example); the rate of PIN verification errors for the ATM 114 exceeds a historical PIN verification error rate by a predetermined degree; and the rate of PIN verification errors due to a user not entering the correct PIN exceeds a historical rate by a predetermined degree. Correspondingly, if the above scenario is detected, the security event manager 204 may generate an alert 190.

As another example, the security event manager 204 may apply one or multiple correlation rules 205 to logged event data 222 for purposes of applying a trending analysis to the logged event data 222. For example, in accordance with some implementations, the logged event data 222 may originate with a store controller 120 or point of sale terminal 118 and may represent a rate at which transactions are occurring with the store controller 120 or point of sale terminal 118. As another example, the logged event data 222 may originate with a particular store controller 120 or point of sale terminal 118 and indicate a rate of transactions conducted that exceed a particular dollar amount. By applying one or more of the correlation rules 205 to the logged event data 222, the security event manager 204 may, for example, identify a particular trend with a dollar amount range (a trend in the number of transaction over $100, for example), a trend in the number of transactions conducted at the endpoint 110, and so forth, which may be associated with one or multiple security issues. Accordingly, the security event manager 204 may generate the corresponding alert(s) 190.

As another example, the security event manager 205 may apply one or more correlation rules 205 to logged event data 222 for purposes of monitoring changes in security policies of the HSMs 153. In this manner, a given HSM 153 may have certain defined security policies, such as security policies that control the storing and managing of keys, and security policies that define the cryptographic procedures that are used by the HSM 153. The security policies that are being implemented by an HSM 153 may be, for example, represented by state data that is stored by the HSM 153. In accordance with example implementations, when the security policy of the HSM 153 changes, this may generate a corresponding event, which is reflected in the logged event data 222. For example, the security policy of a given HSM 153 may prevent the HSM from decrypting keys. However, for improper or appropriate reasons, the security policy of the HSM 153 may change and allow the HSM 153 to now decrypt keys. By applying the correlation rule(s) 205 to the corresponding logged event data 222, the security manager 204 may recognize that this particular security policy change is a security issue that causes a corresponding alert 190 to be generated so that personnel may investigate the security policy change to confirm that the security policy change is authorized and/or take the appropriate corrective action.

As another example, the security event manager 204 may apply one or multiple correlation rules 205 to the logged event data 222 for purposes of identifying security issues arising with the component inventory of the payment network 100. For example, a given host application 154 may be associated with a set of point of sale terminals 118. Each point of sale terminal 118, in turn, may be associated with a Key Set Identifier (KSI), which is used in a Derived Unique Key Per Transaction (DUKPT) and uniquely identifies the point of sale terminal 118. The number of point of sale terminals 118 associated with a given financial institution (associated with a given host application 154, for example) may be in the thousands or tens of thousands. Moreover, it is possible that a rogue point of sale terminal may be connected to the payment network 100 for purposes of conducting fraudulent financial transactions with the payment network 100. By applying one or more correlation rules 205 to the logged event data 222, the security event manager 204 may, in accordance with example implementations, compare the KSIs with the KSIs stored by the HSMs 153 to identify rogue point of sale terminals 118.

Correspondingly, in accordance with example implementations, by performing the inventory and management, the security event manager 204 may generate one or multiple alerts 190 alerting personnel to detected rogue point of sale terminals 118.

The security event manager 204 may also apply the correlation rules 205 to the logged event data 222 to detect transactions associated with unknown components (an unknown point of sale terminal 118, for example) or detect components that have not communicated with the payment network for prolonged periods of time. For example, the security event manager 204 may disable a given point of sale terminal 118 and/or may send an alert 190 to the appropriate security personnel in response to detecting that the point of sale terminal 118 has been inactive for a certain period of time.

As another example, the security event manager 204 may apply the correlation rules 205 to the logged event data 222 to identify health issues that are associated with components of the payment network 100. As examples, the security event manager 204 may, through the application of the correlation rules 205 to the logged event data 222, determine whether a given HSM 153 has a low backup battery level that may adversely affect the HSM's backup power system; whether a given ATM 114 or point of sale terminal 118 has an exceedingly high rate of communication errors (indicating network device failure), whether a PIN entry device of a given ATM 114 has failed (a keypad or keyboard of the ATM 114 has failed, for example); and so forth.

As another example, the security event manager 204 may apply the correlation rules 205 to the logged event data 222 to identify potential malware intrusion. In this context, “malware” refers to machine executable instructions that cause a given component to operate in an unintended manner and may be associated with such malicious software as viruses, worms, Trojan horses, and so forth. The security event manager 204 may apply the correlation rules 205 to the logged event data 222 for purposes of heuristically detecting malware as well as detecting signatures consistent with malware activity.

For the specific example implementation of FIG. 2, the security event manager 204 does not communicate directly with the components of the payment network 100. In this manner, in accordance with some implementations, the SIEM engine 180 may include flexible connectors, or event collector agents 210, where each event collector agent 210 is associated with one or multiple components of the payment network 100 and is responsible for adhering to the appropriate messaging protocols and command sets to communicate with the associated component(s). For example, in accordance with some implementations, a given event collector agent 210 may be associated with a corresponding HSM 153 and thus, may be specifically configured to communicate with the HSM 153 to retrieve event data from the HSM 153; another event collector agent 210 may be associated with a particular class or category of point of sale terminals 118 for purposes of communicating with the point of sale terminals 118 and retrieving event data from the terminals 118; one or multiple other event collector agents 210 may be associated with ATMs 118 for purposes of communicating with and retrieving event data from the ATMs 118; and so forth.

In general, in accordance with example implementations, the event collector agent 210 may be customized to correspond to one or multiple components of the payment network 100 using a script 211. Execution of the script 211 by the event collector agent 210 may correspondingly generate the commands 186 to communicate with the component(s) associated with the event collector agent 210 and retrieve corresponding event data 184. Moreover, a given event collector agent 210 may store multiple scripts 211, where each script 211 is directed to obtain a certain category or class of event data 184 from the associated component(s).

The event data 184 may be associated with multiple categories, or classes, of event data for the component(s). Regardless of its particular form, the event collector agent 210 may, in accordance with example implementations, execute the script 211 or scripts 211 in response to one or multiple commands 208 that are communicated to the event collector agent 210 by the security event manager 204. For example, the security event manager 204 may communicate a given command 208 to an event collector agent 210 for a particular ATM 114, and in response to the command 208, the event collector agent 210 may execute a corresponding script 211 to cause the event collector agent 210 to communicate with the ATM 114 to retrieve a collection of event data 184 from the ATM 114 pertaining to transactions, numbers of transactions, transaction rates, failed ATM transactions, and so forth.

In accordance with some implementations, the event data 184 that is provided by the components of the payment network 100 has a variety of different formats, or organizations that are specific to the components. The event collector agent 210 reformats the event data 184, in accordance with example implementations, to produce formatted event data 214 that has a uniform, or common, format. The formatted event data 214 may be stored, or logged, by a logger 218 of the SIEM engine 180. In this manner, in accordance with example implementations, the formatted event data 214 may be Common Event Format (CEF) data, and the logger 218 may be a system log (syslog), which stores the formatted event data 214 and which is accessible by the security event manager 204. In accordance with example implementations, the security event manager 204 may periodically communicate with the logger 218 to retrieve the corresponding logged event data 222 in the CEF format. Other data formats may be used, in accordance with further example implementations.

In accordance with some implementations, the SIEM engine 180 is a physical machine that includes a memory 230 and one or multiple processors 234. In general, the memory 230 is a non-transitory memory that may be formed from, as examples, semiconductor storage devices, phase change storage devices, magnetic storage devices, memristor-based devices, a combination of storage devices associated with multiple storage technologies, and so forth. Regardless of its particular form, the memory 230 may store various data (the logged event data 222, the formatted event data 214, the event data 184, data describing configuration of the event collector agents 210, data representing the correlation rules 205, and so forth) as well as instructions, that when executed by the processor(s) 234, cause the processor(s) 234 to form one or multiple components of the SIEM engine 180. As examples, the instructions, when executed by the processor(s) 234, may cause the processor 234 to form one or more of the security event managers 204, one or multiple event collector agents 210, the logger 218, and so forth. Moreover, the memory 230 may store a set of the commands 208, a set of the commands 186, and so forth.

In accordance with example implementations, the processor 234 may include one or multiple central processing units (CPUs), one or multiple CPU cores, and so forth.

It is noted that the SIEM engine 180 may be a single physical machine or may be formed from multiple, physical machines in a distributed architecture, depending on the particular implementation. In accordance with some implementations, the SIEM engine 180 may be formed by machine executable instructions that are located on a bank server 150; and as such, the SIEM engine 180 may be associated with a particular host application 154, a particular HSM 153 and a set of endpoints 110. Thus, in accordance with some implementations, the payment network 100 may include multiple SIEM engines 180, where each SIEM engine 180 is associated with a given financial institution.

In accordance with further example implementations, one or multiple components of the SIEM engine 180 may be formed by dedicated hardware or hardware circuits. For example, in accordance with some implementations, one or more components of the SIEM engine 180 may be formed by such dedicated hardware as a field programmable gate array (FPGA) and/or an application specific integrated circuit (ASIC).

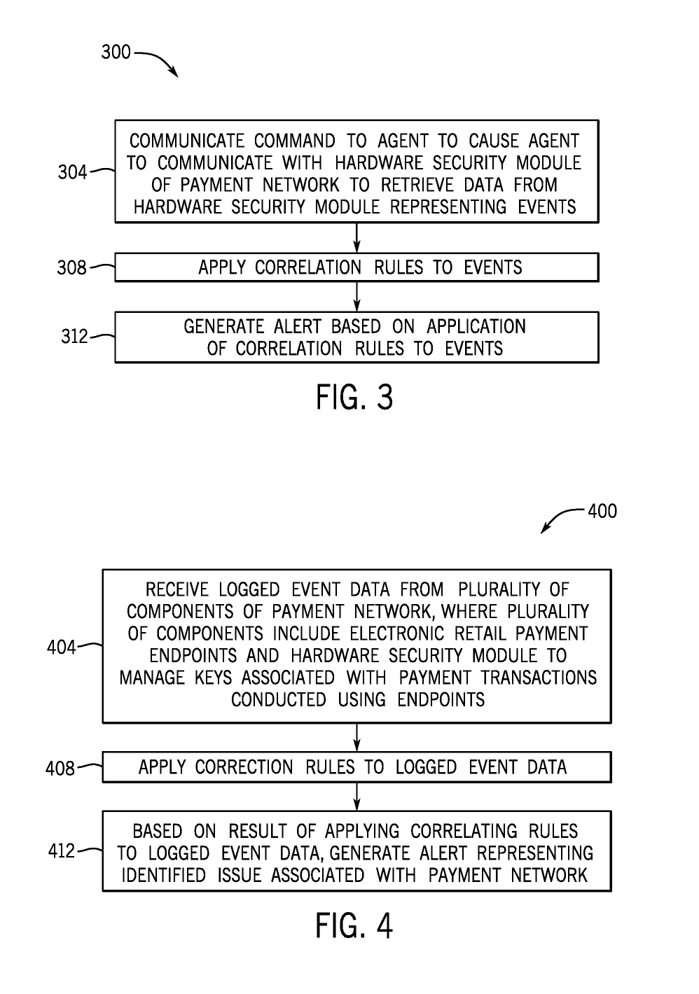

Referring to FIG. 3 in conjunction with FIG. 2, in accordance with example implementations, the SIEM engine 180 may perform a technique 300 that includes communicating (block 304) a command to an agent to cause the agent to communicate with a hardware security module of a payment network to retrieve data from the hardware security module representing events. The technique 300 includes applying (block 308) correlation rules to the events and generating (block 312) an alert based on application of the correlation rules to the events.

More specifically, referring to FIG. 4 in conjunction with FIG. 2, in accordance with some implementations, the SIEM engine 180 may perform a technique 400. The technique 400 includes receiving (block 404) logged event data that is received from a plurality of components of a payment network. The plurality of components includes electronic retail payment endpoints and a hardware security module to manage keys that are associated with payment transactions that are conducted using the endpoints. The technique 400 includes applying (block 408) correlation rules to the logged event data and, pursuant to block 412, based on a result of applying the correlation rules to the logged event data, generating an alert representing an identified issue that is associated with the payment network.

Other implementations are contemplated which are within the scope of the appended claims. For example, although FIG. 2 depicts the SIEM engine 180 as containing event collector agents 210 that communicate on behalf of the security event manager 204 with the components of the payment network 100, in accordance with further example implementations, the security event manager 204 may communicate directly with one or more components of the payment network 100. Moreover, in accordance with some implementations, the security event manager 204 may communicate with some components using an associated event collector agent 210 and communicate directly with other components without use of the intermediary agent 210.

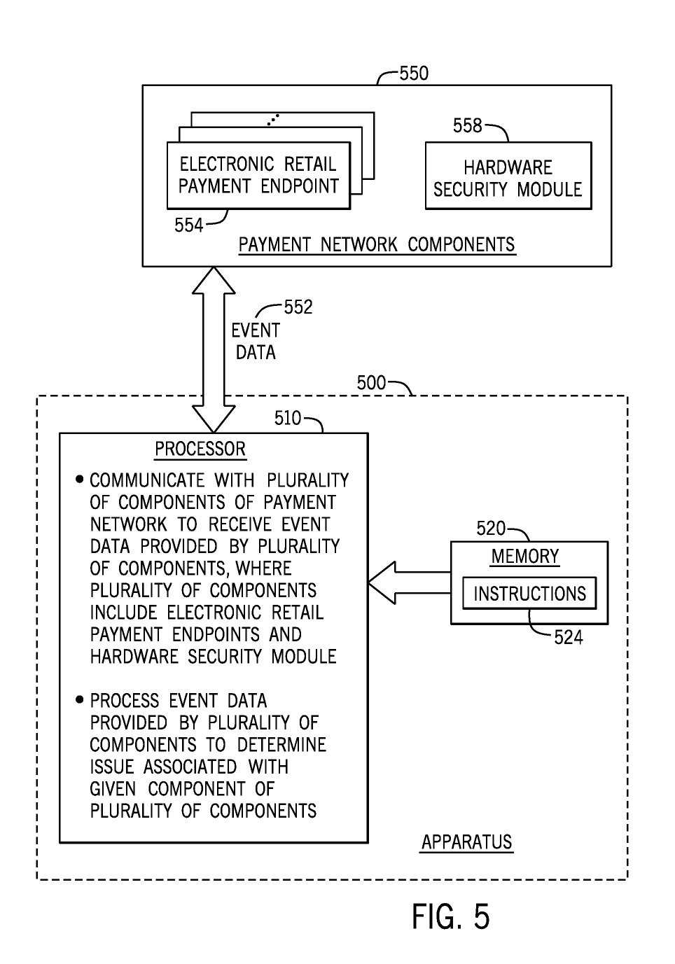

Regardless of the particular process that is used to acquire the logged event data, in accordance with some implementations, an apparatus 500 may be used. Referring to FIG. 5, the apparatus 500 includes a processor 510 and a memory 520 that stores machine executable instructions 524. The machine executable instructions 524, when executed by the processor 510, cause the processor 510 to communicate with a plurality of components 550 of a payment network to receive event data 552 provided by the plurality of components 550. The plurality of components may include electronic retail payment endpoints 554 and a hardware security module 558. The instructions 524, when executed by the processor 510, may cause the processor 510 to process the event data provided by the plurality of components to determine an issue associated with a given component of the plurality of components.

While the present disclosure has been described with respect to a limited number of embodiments, those skilled in the art, having the benefit of this disclosure, will appreciate numerous modifications and variations therefrom. It is intended that the appended claims cover all such modifications and variations.

What is claimed is:

1. A method comprising:
receiving logged event data from a plurality of components of a payment network, wherein the plurality of components comprise electronic retail payment endpoints and a hardware security module to manage keys associated with payment transactions conducted using the endpoints;
applying correlation rules to the logged event data; and
based on a result of applying correlation rules to the logged event data, generating an alert representing an identified issue associated with the payment network.

2. The method of claim 1, wherein the endpoints comprise an automated teller machine, and generating the alert comprises generating an alert representing card skimming occurring at the automated teller machine.

3. The method of claim 2, wherein:
receiving logged event data further comprises receiving first data from the automated teller machine representing a rate of transactions occurring at the automated teller machine and receiving second data from the hardware security module representing a rate at which users of the automated teller machine have not entered a correct personal identification number; and
generating the alert further comprises generating the alert based on the first and second data.

4. The method of claim 3, wherein:
the plurality of components of the payment network further comprises a host application executed by a bank server;
receiving logged event data further comprises receiving third data from the host application representing a rate of verification errors associated with the automated teller machine; and
generating the alert further comprises generating the alert based on the third data.

5. The method of claim 1, wherein generating the alert comprises generating an alert representing detection of an anomalous trend associated with a given endpoint of the plurality of endpoints.

6. The method of claim 5, wherein generating the alert comprises comparing a current transaction rate of the given endpoint with a historical transaction rate of the given endpoint.

7. The method of claim 1, wherein generating the alert comprises detecting a change in a security policy of the hardware security module.

8. The method of claim 1, wherein:
the plurality of endpoints comprise point of sale endpoints; and
the alert is generated based on an inventory of the point of sale endpoints.

9. The method of claim 8, wherein:
the plurality of components comprise a host application executed by a bank server; and
generating the alert based on the inventory further comprises comparing an inventory of the point of sale endpoints represented by data provided by the host application to an inventory determined from data provided by the endpoints.

10. The method of claim 9, wherein:
the plurality of components comprise a host application executed by a bank server; and
generating the alert based on the inventory further comprises:
determining a first inventory based on key set identifiers associated with transactions conducted at the point of sale terminals;
determining a second inventory based on data provided by the host application; and
generating the alert based on a comparison of the first inventory with the second inventory.

11. The method of claim 1, wherein generating the alert further comprises generating the alert based on at least one of a shutdown of the hardware security module or a startup of the hardware security module.

12. An article comprising a non-transitory processor readable storage medium to store instructions that when executed by a processor cause the processor to:
communicate a command to an agent to cause the agent to communicate with a hardware security module of a payment network to retrieve data from the hardware security module representing events;
apply correlation rules to the events; and
generate an alert based on application of the correlation rules to the events.

13. The article of claim 12, wherein the instructions, when executed by the processor, cause the processor to:
receive data from a system log server representing the events; and
selectively generate the alert based on the data received from the system log server.

14. The article of claim 12, wherein the instructions, when executed by the processor, cause the processor to:
communicate a command to at least one other agent to cause the at least one other agent to communicate with at least one other hardware security module of the payment network to retrieve data from the at least one other hardware security module representing events.

15. The article of claim 12, wherein the instructions, when executed by the processor, cause the processor to:
communicate a command to at least one other agent to cause the at least one other agent to communicate with an electronic retail payment endpoint of the network to cause the endpoint to provide data representing events; and
generate the alert based on the application of the correlation rules to events represented by the data provided by the endpoint and events represented by the data provided by the hardware security module.

16. The article of claim 12, wherein the instructions, when executed by the processor, cause the processor to generate the alert in response to the application of the correlation rules identifying a trend that exceeds a threshold, an unaccounted inventory change in point of sale endpoints of the network, card skimming or a change in a security policy of the hardware security module.

17. An apparatus comprising:
a processor; and
a memory to store machine executable instructions that, when executed by the processor, cause the processor to:
communicate with a plurality of components of a payment network to receive event data provided by the plurality of components, wherein the plurality of components comprise electronic retail payment endpoints and a hardware security module;
process the event data provided by the plurality of components to determine an issue associated with a given component of the plurality of components.

18. The apparatus of claim 17, wherein the instructions, when executed by the processor, cause the processor to:
provide commands to agents to communicate with the plurality of components to receive the event data;
log the event data; and
convert the logged event data into a common format.

19. The apparatus of claim 17, wherein the hardware security module manages keys associated with payment transactions conducted using the endpoints of the payment network.

20. The apparatus of claim 17, wherein the machine executable instructions, when executed by the processor, cause the processor to apply correlation rules to the event data to determine the issue.
